(19) United States
(12) Patent Application Publication
(10) Pub. No.: US 2004/0035838 A1
(43) Pub. Date: Feb. 26, 2004

(54) Method and plasma torch for treating a surface in a cavity and related filling-closure installation

(76) Inventors: Rene Merard, Chilly-Mazarin (FR); Roger Leclerq, Igny (FR); Betty Merard, Saint-Cyr L'Ecole (FR); Jean Rene Michel Merard, Chilly-Mazarin (FR); Carole Merard, La Celle Saint Cyr (FR)

Correspondence Address: YOUNG & THOMPSON, 745 SOUTH 23RD STREET 2ND FLOOR, ARLINGTON, VA, 22202

(21) Appl. No.: 10/257,770

(22) PCT Filed: Apr. 17, 2001
(86) PCT No.: PCT/FR01/01168

(30) Foreign Application Priority Data
Apr. 17, 2000 (FR) 00/04947

(51) Int. Cl. B23K 9/00

(52) U.S. Cl. 219/121.43

(57) ABSTRACT

A plasma torch includes a distal part (4) immersed in a container (43) to be decontaminated. A plasma jet (44) produced by sudden discharge of a capacitor between main electrodes (9,11) sweeps directly or by reflection or by sweep-over the whole internal surface of the container (43). The gas exhaust is preferably controlled by a valve (47) operating by gravity on the orifice (42) of the container. The torch is useful for intense decontamination, in particular at a high rate, using an extremely brief and intense plasma flash.

The present invention relates to a method for treating a surface in a cavity at substantially atmospheric pressure.

The present invention also relates to a plasma torch for the implementation of this method.

The present invention furthermore relates to a filling-closure installation in which the decontamination of containers is carried out using the method and with the torch according to the invention.

The expression “to treat” a surface or “treatment” of a surface in a cavity is hereafter understood to mean any action modifying an exposed surface in the cavity as regards its physical state, for example its roughness, its microbiological state, etc.

The word “decontamination” is understood to mean a “treatment” of elimination of non-living residues and micro-organisms, in particular after the surface has undergone normal washing and rinsing operations.

The word “sterilisation” is understood to mean “decontamination” such as applied in order to eliminate micro-organisms.

The present invention relates, in particular but not limitatively, to the decontamination of containers and caps before filling, in particular in the context of an industrial filling-closure line.

The treatment methods consisting of putting the inside surface of containers in contact with chemical substances generate many problems, particularly the duration of implementation, the required quantities of chemical substances, the problems of reprocessing or elimination of these substances after their use, the necessity of then carrying out one or more rinsings and dryings of the container and then of treating the products of rinsing.

It has also been sought to treat the inside surface of containers using various forms of plasma, as disclosed in particular by WO-A-97/183 43. This document describes plasma generation maintained by an alternating current source. Several implementations are described, either by introducing electrodes into the container, or by generating a capacitive type plasma following lines of current traversing the wall of the container assumed to be made of dielectric material.

The documents WO-A-95/51608 and WO-A-98/51609 also describe a capacitive H.F. plasma, giving details of its principle, using an external electrode closely following the shape of the container to be disinfected. Such an arrangement is very restrictive for a sterilisation device on a filling-closure line, which must generally be able to operate with containers (bottles, etc) of very diverse shapes and sizes.

These methods suffer from numerous limitations. They necessitate very high installed electrical power or a treatment time which can be incompatible with the production rate of an industrial line and/or with the necessity of not damaging the container, in particular if it is made of plastic.

According to Patent Application No. 98 01 811 in the name of the applicant, there is also known a device capable of successively scouring a surface by means of electrical discharges generating, at atmospheric pressure or under a controlled atmosphere, brief and powerful pulsed plasma jets. The device is used by displacing the ejection orifice of the plasma opposite the surface to be scoured at a displacement speed which is compatible with the rate of production of the discharges and the scouring effect obtained at each discharge.

The object of the invention is to provide a method and a device of the type mentioned at the beginning which are capable of treating, in particular, of decontaminating or sterilising, efficiently and rapidly, a surface in a cavity and, in particular, the inside surface of a hollow body such as a container or a cap, and which in particular lends itself well to integration in an industrial bottling line.

According to the invention, the method for treating at least one surface in a cavity by means of a plasma torch emerging inside the cavity is characterized in that, starting from an arc chamber of the torch, a pulse-type plasma jet is generated, such that by sudden expansion of the plasma outside of the chamber, the jet produced by one pulse substantially sweeps the entire inside of the cavity.

The invention is based on the discovery that a plasma jet produced by a brief and powerful pulse, when this jet is ejected into the inside of a container, generally sweeps the totality of the inside surface of the container and, in most case, treats and, in particular, decontaminates this surface entirely.

Preferably, the cavity can be placed in a situation of confinement or virtual confinement prior to and during the generation of the jet.

Considering the peak powers (typically 1 MW) delivered during the very brief plasma jet (typically 50 to 1000 μs), the properties of the plasma jet are particularly high: ultra violet flash of low wavelength and thermal flash. Due to the confinement which is preferably carried out over the hollow body just before the generation of the jet, there is no, or only very little, plasma ejected out of the hollow body, and the totality of the energy imparted to the plasma is dissipated inside this hollow body. Furthermore, the briefness of the jet ensures that the action of the plasma on the walls of the hollow body is applied only to the extreme surface of the material without damaging the latter in depth.

In other words, according to a concept which is the basis of the invention, the briefer the jet, the more active it is regarding the sought objective and the less harmful it is to the surface itself.

The hollow body to which this decontamination method is applied can be a container intended to be filled (flasks, bottles, pots, tubes, etc), and also the cap which will be used to obturate it, and which must be free of contamination.

Even though it is possible to treat the whole inside of a container with a single pulse, it is possible to choose to carry out the treatment with a small number of successive pulses, for example two to four of them, either at a single treatment station or at successive treatment stations. Each pulse can thus have reduced power.

The cavity can also consist of the inside surface of a cap that has to be perfectly clean just before its use for obturating a container.

According to a second aspect of the invention, the plasma torch for the implementation of the aforementioned method, comprises an elongate body in which is defined the arc chamber, having an ejection orifice at one end designed to be inserted into the cavity, a proximal main electrode and a distal main electrode connected to each other by a capacitor, axially spaced in the chamber, means of producing a triggering pulse in a starting circuit passing through a part of the arc chamber in the vicinity of the proximal electrode, and power supply means for charging the capacitor.

When the triggering pulse is produced in the starting circuit, a small-sized arc is formed in a part of the arc chamber in the vicinity of the proximal electrode which is preferably the cathode. The ionisation which results from this for the gas contained between the main electrodes causes the sudden discharge of the capacitor through a circuit passing through the gaseous space of the chamber between the electrodes. The rapid and intense heating of the gas causes its expulsion out of the chamber and into the whole inside space of the cavity.

According to a third aspect of the invention, the filling-closure installation comprises means of transferring containers through various successive stations, at least one of these stations being a treatment station comprising a torch according to the second aspect, and a means of relative displacement between the torch and the container for the insertion and extraction of the torch with respect to the container.

Other features and advantages of the invention will furthermore emerge from the following description, relating to non-limitative examples.

In the appended drawings:

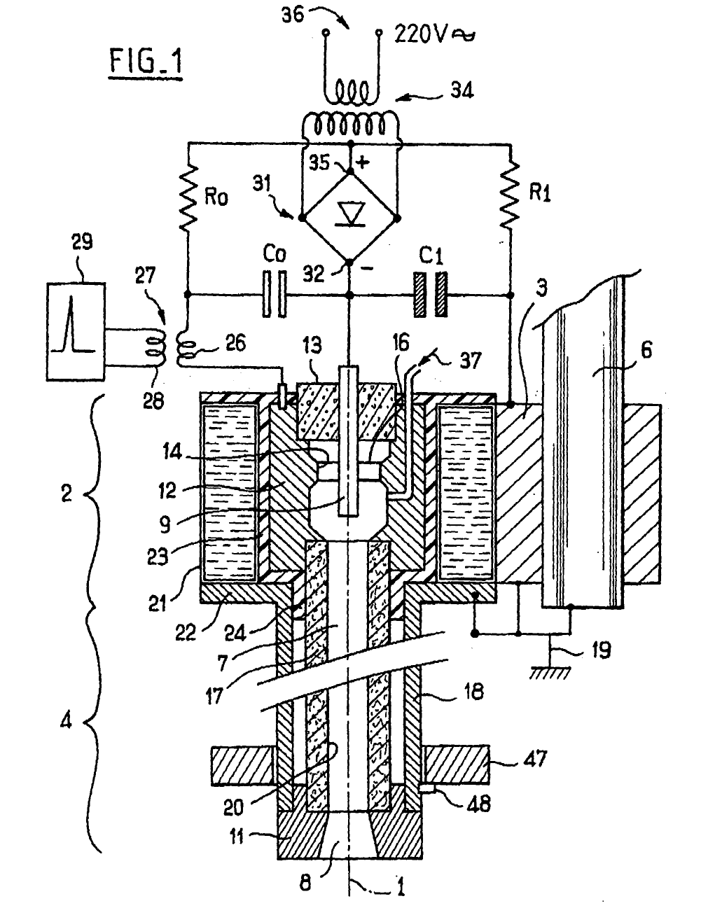

FIG. 1 is a diagrammatic view, in axial cross-section, of a plasma torch according to the invention, and of some elements of the associated electrical circuit;

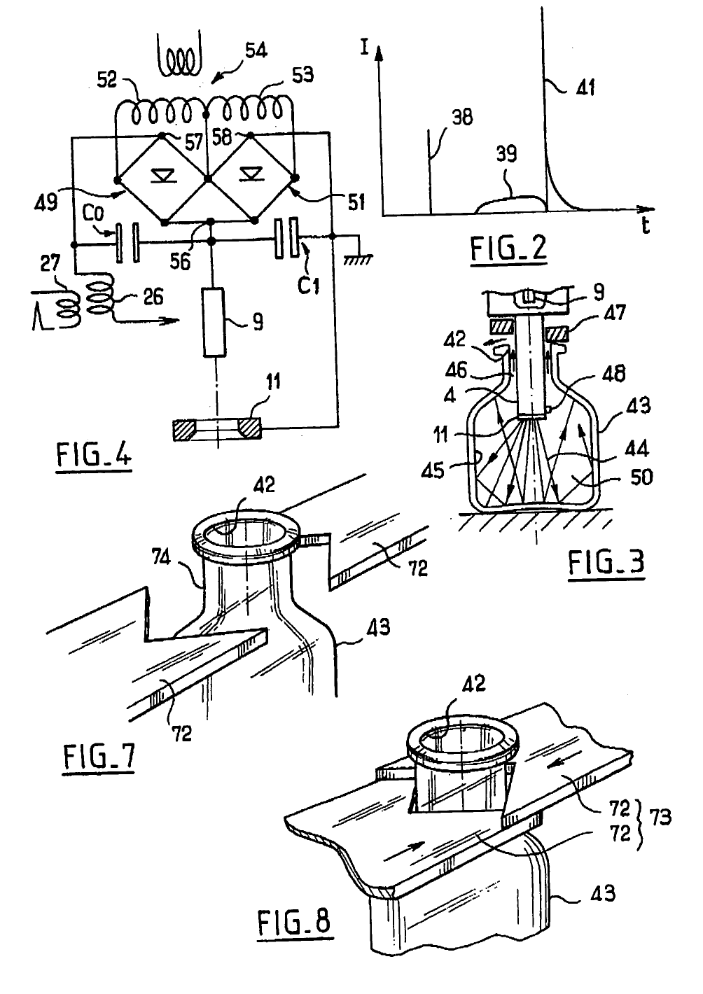

FIG. 2 is a graph of the current I passing through the proximal main electrode as a function of time t;

FIG. 3 is a diagrammatic view of the torch producing a plasma jet inside a bottle;

FIG. 4 shows a modified electrical circuit;

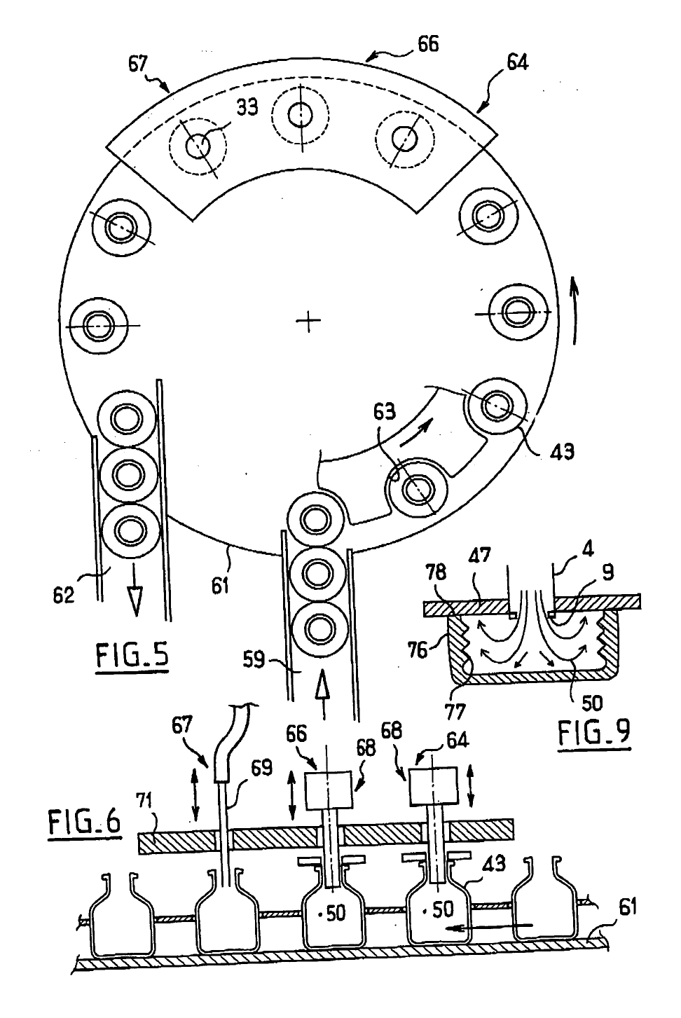

FIG. 5 is a partial plan view of a filling-closure line;

FIG. 6 is a side elevational view of the bottle decontamination and filling station;

FIGS. 7 and 8 partially show, in perspective, a means of centring a bottle in two successive functional steps; and

FIG. 9 shows the application of the method according to the invention to the decontamination of a cap.

In the example shown in FIG. 1, the torch has a body elongated along the axis 1. The body consists of a proximal part 2 fixed to a support 3 and a distal part 4 of generally cylindrical shape, centred on the axis 1. The distal part 4 has an external diameter appropriate for being inserted with a suitable play, for example of two or three millimetres, through the orifice of a container, such as a bottle, to be decontaminated.

For the movement of insertion into and extraction from the container, the support 3 is movable parallel with the axis 1 by being itself secured to a column 6 movable along its own axis parallel with the axis 1. In the example shown, the axis 1 is vertical and the distal part 4 is directed downwards in order to penetrate into a container whose orifice faces upwards.

The body 2, 4 defines in its interior an axial chamber 7 which is open for communication with the outside through the free end of the distal part 4, through an ejection orifice 8. The body carries two main electrodes which are exposed in the chamber 7, and more particularly a proximal electrode 9 which is a cathode in the form of an axial rod protruding into the chamber 7 from its proximal end, and a distal electrode 11 which is an anode in the example and which has an annular shape centred on the axis 1. The radially inner surface of the anode 11 defines the ejection orifice 8.

There is also in the body of the torch a starting electrode 12 made in the form of a ring whose radially internal face is exposed in the chamber 7 around the cathode 9. The starting electrode is insulated with respect to any direct or indirect contact with the cathode 9 by a ceramic ring 13 interposed between them. The starting electrode 12 has an annular protrusion directed radially inwards and more precisely towards the proximal electrode 9 in order to establish between the starting electrode 12 and the proximal electrode 9 a narrow annular space 16 provided for the appearance of a starting arc of the “thin arc” type, that is to say a substantially thread-like arc.

The distal electrode 11 is insulated from the starting electrode 12 by a ceramic tube 17 inserted between them and whose internal surface 20 constitutes a part of the inside surface of the chamber 7 after the electrode 12. The main electrodes 9 and 11 are thus normally electrically insulated from each other by the succession of the ceramic ring 13 and the ceramic tube 17, between which the starting electrode 12 is located.

The outer wall of the distal part 4 is constituted by a tube 18 made of heat and electricity conducting material such as copper. The tube 18 is in electrical contact with the anode 11 in order to serve as a current return means. The tube 18 is connected to earth as are the support 3 and the column 6, as shown at 19. The proximal part 2 of the body comprises an annular box 21 surrounding the starting electrode 12 and used for the circulation of a cooling fluid such as water arriving and leaving through connectors that are not more shown. The box 21 is in thermal contact with a proximal collar 22 of the electrical and thermal return tube 18. The collar 22 forms the base of the proximal part 2 of the body. An electrical insulator 23 forms a continuity of insulation between the ring 13 and the ceramic tube 17 all around the axis 1 and extending between the starting electrode 12 and the box 21, then between the electrode 12 and the collar 22 and finally, at one end 24, between the ceramic tube 17 and the copper return tube 18.

The insulator 23 is chosen in a quality and thickness sufficient to ensure the necessary insulation, in particular between the starting electrode 12 and the box 21, but with a thickness that is nevertheless as thin as reasonably possible in order to minimise the attenuation of thermal transfers between the starting electrode 12 and the cooling circuit in the box 21.

A power capacitor C1 is connected between the two main electrodes 9 and 11. One of the electrodes of the capacitor C1 is connected in an electrically direct manner with the cathode 9 and the other electrode of the power capacitor C1 is connected in an electrically direct manner with the anode 11. A starting capacitor C₀, of lower capacity, comprises one electrode connected in an electrically direct manner to the cathode 9 and another electrode connected to the starting electrode 12 through the secondary 26 of a starting transformer 27 whose primary 28 is connected to the output terminals of an initiation device 29 intended to produce a voltage pulse in the primary 28.

The circuit furthermore comprises a rectifier 31 producing between its output terminals 32 and 33 a rectified voltage generated from an alternating voltage of, for example, 600 volts provided by a power supply transformer 34 whose input terminals are connected to the mains 36.

The output terminal 32 of the rectifier 31 is directly connected on the one hand to the cathode 9 and on the other hand to a first terminal of each one of the capacitors C₀ and C₁. The positive terminal 33 of the rectifier 31 is connected to the other terminal of each one of the capacitors C₀ and C₁ through a respective resistor R₀ and R₁.

The electrical and physical operation of the torch itself is as follows:

the rectifier 31 continuously recharges the capacitors C₀ and C₁. The chamber 7 connects with atmospheric air and continuously receives a small flow 37 of gas for protecting the cathode 9 (typically nitrogen or argon for example) injected into the chamber 7 in the vicinity of the cathode 9: the sought objective is to prevent any oxidation of the cathode, which is the most stressed electrode. For this purpose, the protective gas can furthermore be doped with hydrogen.

in order to trigger the emission of a plasma jet, the device 29 is controlled to produce a current pulse. As a result, there occurs a voltage pulse in the secondary 26 of the starting transformer 27. The voltage pulse causes appearance of a thin arc between the starting electrode 12 and the cathode 9. This results in a current pulse 38 (FIG. 2) through the cathode 9. Ions are henceforth present in the space 16 between the electrodes 9 and 12 and are distributed in that space until this allows the starting capacitor C₀ to discharge by means of a current passing between the starting electrode 12 and the main electrode 9 in a stage corresponding to zone 39 of the graph shown in FIG. 2. The starting plasma thus created finishes by invading the chamber 7 and making the space between the main electrodes 9 and 11 conductive. The power capacitor C₁ then discharges very rapidly through the main electrodes 9 and 11 and the inter-electrode space located between them in the chamber 7, as illustrated by the peak 41 in FIG. 2. During this discharge, the gas present in the chamber 7 is suddenly heated up to a temperature of more than 10,000° K, which causes its sudden expansion and its ejection through the ejection orifice 8.

Thus, when the distal part 4 of the torch is inserted, as shown in FIG. 3, through the orifice 42 of a container 43 to be decontaminated, the plasma jet 44 will strike and/or sweep over, directly and/or by successive reflection, the totality of the inside surface 45 of the container 43.

It falls within the scope of the invention, non-limitatively, to regulate the gas exhaust from the cavity 50 constituted by the inside of the container. The confinement of the hollow body, as already indicated, is sought just before the triggering of the plasma jet, for reasons of efficiency of the sterilisation. It is also sought for reasons of attenuation of the sound wave (noise) accompanying the ejection of the plasma from the chamber, and to make the sound level compatible with work safety standards.

Finally, a pressure peak develops in the hollow body during the ejection of the plasma, the maximum value depending, among other things, on the degree of confinement achieved.

For all of these reasons, the regulation of the plasma exhaust, able to be as much as a total confinement of the hollow body, is a significant parameter of the invention.

The confinement device can act as a valve with respect to pressures that are too high and risk causing a tearing or explosion of the hollow body. An illustration of such a device is given in FIG. 3 where a valve 47 which normally rests on the orifice of the container (the right-hand part of FIG. 3), but which rises from it (the left-hand part of FIG. 3) when a certain pressure threshold is exceeded in the container. As shown in FIG. 1, such a valve is advantageously produced in the form of a ring of appropriate weight which is mounted such that it slides along the distal part 4, and therefore about the return tube 18 in the example shown, whilst being prevented from escaping by stop pins 48 limiting its travel towards the distal end of the torch.

In the example of FIG. 1, the resistors R₀ and R₁ have the function of preventing the power capacitor C₁ from discharging through the starting electrode 12 and also of isolating the positive terminal of the starting capacitor C₀ from earth. On the other hand, these resistors have the drawback of slowing down the charging up of the capacitors and of consuming power by the Joule effect.

In the example shown in FIG. 4, which will be described only where it differs from that shown in FIG. 1, the means of charging the power capacitor C₁ and the means of charging the starting capacitor Cₒ each comprise a rectifier 49, 51, whose input terminals are connected to two separate secondaries 52 and 53 of the power supply transformer 54. The two rectifiers 49, 51 have a common first output terminal 56 connected, as in the previous example, to the cathode 9 and to one of the terminals of each of the capacitors C₀ and C₁. The other output terminal 57 of the rectifier 49 is connected directly to the junction point between the starting capacitor C₀ and the secondary 26 of the starting transformer 27. The other terminal 58 of the rectifier 51 is separate from the terminal 57 and is connected directly to the other terminal of the power capacitor C₁, and to the anode 11 and consequently to earth. This circuit is appropriate for high rates since it makes it possible to recharge the capacitors faster after each production of a plasma jet.

Other arrangements are possible, allowing the energy used in the power discharge to be varied (in order to adapt it to the volume of the bottle to be sterilised) whilst maintaining the starting energy at a fixed value.

One of the preferred features of the method according to the invention is that, during the plasma jet (FIG. 3), the distal main electrode 11 is located inside the cavity 50 whilst the proximal electrode 9 is located outside of it. In this way there is avoidance of the dilemma in which WO-A-97/18343 is trapped which consists either in totally inserting into the inside of the container a small-sized plasma-producing device, or in sending into the container a plasma generated outside of it, or even in resorting to a capacitive plasma by means of an electrode surrounding the container. The invention makes it possible to treat a container my means of a plasma generated in situ in an arc chamber of sufficient size for the plasma obtained by a single pulse to be more than enough to treat efficiently the whole of the inside of the container.

This arrangement, made possible by the design of the plasma torch, makes it possible to release the plasma directly inside the hollow body to be sterilised, with no external losses, making it possible to achieve a confinement easily just before the triggering of the jet. The design of the torch finally makes it possible to obtain a distal part of small diameter (of the order of 10 to 20 mm) compatible with the diameter of the neck of most of the containers for which it is intended.

FIGS. 5 and 6 show a treatment and filling-closure line for bottles implementing the invention. The bottles to be filled arrive via a feed conveyor 59 at a rotary carrousel 61 in order to leave it in the form of filled and closed bottles via an outgoing conveyor 62. During the rotation, the bottles 43 can be positioned in cells 63 rotating with the carrousel. The rotation of the carrousel 61 is intermittent with, between two stoppages, a forward step corresponding to the succession pitch of the cells 63. In a way that is not shown in detail, each bottle 43 thus encounters, successively, for example washing, rinsing and drying stations, if these are necessary, and then two decontaminations stations 64 and 66, a filling station 67 and a closure station, etc.

As shown in FIG. 6, each of the decontamination stations 64 and 66 can be equipped with a torch 68 according to the invention. The two torches 68 and a filling nozzle 69 of the filling station 67 can be fixed to a same plate 71 which rises during the rotation of the carrousel 61 and then descends again in order to simultaneously insert into three successive bottles 43, on the one hand the two torches 68 at the decontamination stations 64 and 66 and, on the other hand, the filling nozzle 69 at the station 67. Whilst the container 43 located at station 67 is being filled, the preceding two containers are being decontaminated in masked time. Each container therefore undergoes two successive decontaminations. This makes it possible to use a lower power for each plasma jet and to increase significantly the service life of the electrodes or to increase the pulse rate.

FIGS. 7 and 8 show another embodiment of an industrial line. In order to centre the container 43 accurately before inserting the torch into the orifice 42 of the container, the container is grasped between two concave dihedral-shaped jaws 72 of a centring clamp 73. The jaws 72 are movable with respect to each other between a withdrawn position, shown in FIG. 7, where they allow arrival of the neck 74 of a container 43 between them, and a centring position in which they define between them an opening adapted to the perimeter of the container. The perfectly symmetrical movement of the two jaws 72 with respect to the future axis of introduction movement of the torch in the container ensures a perfect centring of the container with respect to this axis. It is thus possible to use a torch having an outer diameter exhibiting only a slight play in the neck of the container. This can dispense with the use of the valve 47 whilst still having a state of virtual confinement in the container during the treatment, apart from a slight flow of decontaminating gas along the inside surface of the neck.

In the example shown in FIG. 9, the cavity to be treated is the inside surface of a cap 76, having an internal thread 77. In this case a valve 47 of appropriate diameter is used to press on the free edge 78 of the cap 76. Considering the small axial depth of a cap, the torch penetrates a relatively small way into the inside space of the latter. The decontamination principle remains the same however. Tests have shown that even the recesses of the thread 77 were appropriately decontaminated without the mechanical quality of the surface of the thread being damaged.

By way of example, there has been used a plasma torch according to the invention whose main characteristics were as follows:

inside diameter of the arc chamber 7=8.0 mm

outside diameter of the distal part 4=18 mm

distance between the main electrodes 9 and 11=45 mm

discharged energy=420 J

duration of the discharge=<1 ms

bottle treated=100 ml bottle

diameter=40 mm, height=100 mm

inside diameter of the neck=20 mm

strain deposited in the bottle: spores of bacillus stearothermophilus, concentration of between 2.10⁵ CFU (colony-forming units) and 5.10⁵ CFU, deposited on the bottom and on the inside surface of the neck.

Only one single plasma pulse in each of the 30 bottles tested.

Result: residual number of CFU: 0

The invention is not of course limited to the examples described and shown.

The invention is applicable to unit decontamination, for example in the laboratory.

It is also envisaged, according to the invention, to produce several successive jets, for example two to four, for decontaminating the same bottle using one and the same torch.

The industrial application of the invention has been illustrated in the form of a station in a machine comprising multiple stations. The invention is also, however, applicable in the form of a specific machine intended, for example, to be interposed between two pre-existing machines in an initially conventional installation.

1. Method for treating, and in particular for sterilising, at least one surface (45, 77) in a cavity by means of a plasma torch (68) emerging inside the cavity, characterized in that, starting from an arc chamber (7) of the torch, a pulse-type plasma jet (44) is generated, such that by sudden expansion of the plasma outside of the chamber (7), the jet produced by one pulse substantially sweeps the entire inside of the cavity.

2. Method according to claim 1, characterized in that, during the treatment, at least one restriction of the plasma exhaust out of the cavity is carried out.

3. Method according to claim 1 or 2, characterized in that during the treatment the cavity is obturated by a valve (47) capable of opening at a predetermined excess pressure.

4. Method according to claim 1 or 2, characterized in that an annular valve (47), mounted such that it slides around the torch, is caused to rest by gravity on the edge of the orifice (42).

5. Method according to one of claims 1 to 4, characterized in that the pulse-type jet is produced in the torch by causing the appearance of an electrical starting arc in a part of a space located between two main electrodes (9, 11) separated from each other along the interior of the torch and connected to the terminals of a previously charged power capacitor (C₁).

6. Method according to claim 5, characterized in that the starting arc is produced by discharging a starting capacitor (C₀) on at least one starting electrode (12) separate from the main electrodes (9, 11).

7. Method according to one of claims 1 to 6, characterized in that, during the jet (44) a main electrode (11) of the torch, preferably located in the vicinity of its output orifice (8) is situated inside the cavity.

8. Method according to claim 7, characterized in that another main electrode (9) located inside the chamber (7) is at this time situated outside of the cavity.

9. Method according to one of claims 1 to 8, characterized in that the chamber (7) is supplied with a doped or non-doped gas (37) for protecting the electrodes.

10. Method according to one of claims 1 to 9, characterized by producing in the cavity a small number of successive pulse jets, of the order of two to four.

11. Method according to one of claims 1 to 10, characterized by treating, as said surface, the inside surface of a cap (76) prior to closing of a container.

12. Method according to one of claims 1 to 10, characterized by treating, as said surface, the inside surface of a container (43) in order to decontaminate it prior to filling of the container.

13. Method according to claim 12, characterized in that the said internal surface is treated in a filling-closure installation whilst another previously treated container is being filled at another station (67) of the installation.

14. Method according to claim 12 or 13, characterized in that the said internal surface is treated in a filling-closure installation whilst another container is undergoing a second pulse-type plasma jet at a second plasma treatment station (66).

15. Method according to one of claims 12 to 14, characterized in that, prior to generation of the jet, the container is grasped between two centring jaws (72) and a relative axial movement between the container (43) and the torch is carried out in order that the torch partially penetrates inside the container.

16. Method according to one of claims 1 to 15, characterized in that the peak power delivered during the plasma pulse is of the order of one megawatt.

17. Plasma torch for implementing the method according to one of claims 1 to 16, comprising an elongate body (2, 4) in which is defined the arc chamber (7), having an ejection orifice (8) at one end designed to be inserted into the cavity, a proximal main electrode (9) and a distal main electrode (11) connected by a power capacitor (C₁), axially spaced in the chamber, means of producing a triggering pulse in a starting circuit passing through a part (16) of the arc chamber in the vicinity of the proximal electrode (9, 11) and power supply means (34, 31; 54, 51) for charging the power capacitor (C₁).

18. Torch according to claim 17, characterized by comprising an annular obturator (47) sliding about the elongate body, and stop means (48) limiting travel of the obturator towards the ejection orifice (8).

19. Torch according to claim 17 or 18, characterized in that the distal electrode (11) which is closest to the ejection orifice (8) is connected to the electrical earth and to the thermal earth by a tube made of electrically and thermally conductive material (18), forming part of a body of the torch.

20. Torch according to claim 19, characterized in that the tube (0.18) is in contact with a cooling circuit (21).

21. Torch according to one of claims 17 to 20, characterized in that the starting circuit comprises:
a starting electrode (12) disposed laterally in the chamber (7) in the vicinity of the proximal main electrode (9);
a starting capacitor (C₀) connected in series with the secondary (26) of a starting transformer (27) between the proximal electrode (9) and the starting electrode (12); and
means (31, R₀; 49) for charging the starting capacitor (C₀).

22. Torch according to claim 21, characterized in that the starting electrode (12) is a conductive ring forming an annular protrusion (14) facing the proximal electrode (9).

23. Torch according to claim 21 or 22, characterized in that the means for charging the power capacitor (C₀) and the means for charging the starting capacitor (C₁) comprise a common rectifier (31), whose input is connected to a power supply source (34) and having an output terminal (32) connected to one of the main electrodes (9) and to one terminal of each of the two capacitors (C₀, C₁), and another output terminal (33) connected through a first resistor (R₁) to the other terminal of the power capacitor (C₁) and to the earth and through a second resistor (R₀) to the other terminal of the starting capacitor (C₀) and to the starting electrode (12).

24. Torch according to claim 21 or 22, characterized in that the means for charging the power capacitor (C₁) and the means for charging the starting capacitor (C₀) each comprise a rectifier (51, 49), whose input is connected to a power supply source (53, 52) and having a common output terminal (56) connected to one of the main electrodes (9) and to a common terminal of the two capacitors, and each having another respective output terminal (58, 57) connected to the other terminal of the respective capacitor.

25. Torch according to one of claims 17 to 24, characterized in that it is fitted such that it is mobile, preferably in vertical translation, for a movement of insertion and extraction with respect to a container to be treated (43).

26. Filling-closure installation comprising means (59, 61, 62) of transferring containers (43) through various successive stations, at least one of these stations being a decontamination station (64, 66) comprising a torch (68) according to one of claims 17 to 22, and a means of relative displacement (71) between the torch (68) and the container (43) for the insertion and extraction of the torch with respect to the container.

27. Installation according to claim 26, characterized in that the means of relative displacement simultaneously drives the filling nozzle (69) of a filling station (67) located downstream of the decontamination station.

28. Installation according to claim 26 or 27, characterized in that the decontamination station comprises a centring clamp (73), provided with two concave dihedral-shaped centring jaws (72) mobile with respect to each other in order to define between them an opening adapting to the perimeter of the container (43).

5. (amended) Method according to claim 1, characterized in that the pulse-type jet is produced in the torch by causing the appearance of an electrical starting arc in a part of a space located between two main electrodes (9, 11) separated from each other along the interior of the torch and connected to the terminals of a previously charged power capacitor (C₁).

7. (amended) Method according to claim 1, characterized in that, during the jet (44) a main electrode (11) of the torch, preferably located in the vicinity of its output orifice (8) is situated inside the cavity.

9. (amended) Method according to claim 1, characterized in that the chamber (7) is supplied with a doped or non-doped gas (37) for protecting the electrodes.

10. (amended) Method according to claim 1, characterized by producing in the cavity a small number of successive pulse jets, of the order of two to four.

11. (amended) Method according to claim 1, characterized by treating, as said surface, the inside surface of a cap (76) prior to closing of a container.

12. (amended) Method according to claim 1, characterized by treating, as said surface, the inside surface of a container (43) in order to decontaminate it prior to filling of the container.

14. (amended) Method according to claim 12, characterized in that the said internal surface is treated in a filling-closure installation whilst another container is undergoing a second pulse-type plasma jet at a second plasma treatment station (66).

15. (amended) Method according to claim 12, characterized in that, prior to generation of the jet, the container is grasped between two centring jaws (72) and a relative axial movement between the container (43) and the torch is carried out in order that the torch partially penetrates inside the container.

16. (amended) Method according to claim 1, characterized in that the peak power delivered during the plasma pulse is of the order of one megawatt.

17. (amended) Plasma torch for implementing the method according to claim 1, comprising an elongate body (2, 4) in which is defined the arc chamber (7), having an ejection orifice (8) at one end designed to be inserted into the cavity, a proximal main electrode (9) and a distal main electrode (11) connected by a power capacitor (C₁), axially spaced in the chamber, means of producing a triggering pulse in a starting circuit passing through a part (16) of the arc chamber in the vicinity of the proximal electrode (9, 11) and power supply means (34, 31; 54, 51) for charging the power capacitor (C₁).

19. (amended) Torch according to claim 17, characterized in that the distal electrode (11) which is closest to the ejection orifice (8) is connected to the electrical earth and to the thermal earth by a tube made of electrically and thermally conductive material (18), forming part of a body of the torch.

21. (amended) Torch according to claim 17, characterized in that the starting circuit comprises:
a starting electrode (12) disposed laterally in the chamber (7) in the vicinity of the proximal main electrode (9);
a starting capacitor (C₀) connected in series with the secondary (26) of a starting transformer (27) between the proximal electrode (9) and the starting electrode (12); and
means (31, R₀; 49) for charging the starting capacitor (C₀).

23. (amended) Torch according to claim 21, characterized in that the means for charging the power capacitor (C₀) and the means for charging the starting capacitor (C₁) comprise a common rectifier (31), whose input is connected to a power supply source (34) and having an output terminal (32) connected to one of the main electrodes (9) and to one terminal of each of the two capacitors (C₀, C₁), and another output terminal (33) connected through a first resistor (R₁) to the other terminal of the power capacitor (C₁) and to the earth and through a second resistor (R₀) to the other terminal of the starting capacitor (C₀) and to the starting electrode (12).

24. (amended) Torch according to claim 21, characterized in that the means for charging the power capacitor (C₁) and the means for charging the starting capacitor (C₀) each comprise a rectifier (51, 49), whose input is connected to a power supply source (53, 52) and having a common output terminal (56) connected to one of the main electrodes (9) and to a common terminal of the two capacitors, and each having another respective output terminal (58, 57) connected to the other terminal of the respective capacitor.

25. (amended) Torch according to claim 17, characterized in that it is fitted such that it is mobile, preferably in vertical translation, for a movement of insertion and extraction with respect to a container to be treated (43).

26. (amended) Filling-closure installation comprising means (59, 61, 62) of transferring containers (43) through various successive stations, at least one of these stations being a decontamination station (64, 66) comprising a torch (68) according to claim 17, and a means of relative displacement (71) between the torch (68) and the container (43) for the insertion and extraction of the torch with respect to the container.

28. (amended) Installation according to claim 26, characterized in that the decontamination station comprises a centring clamp (73), provided with two concave dihedral-shaped centring jaws (72) mobile with respect to each other in order to define between them an opening adapting to the perimeter of the container (43).
